(19) United States
(12) Patent Application Publication
(10) Pub. No.: US 2017/0221101 A1
(43) Pub. Date: Aug. 3, 2017

(54) METHOD AND A SYSTEM FOR ADVERTISING

(71) Applicant: Qubercomm Technologies Inc, Walnut, CA (US)

(72) Inventors: Senthil Kumar BALASUBRAMANIAN, Chennai (IN); Sudarsan VASUDEVAN, Chennai (IN); Sundar SUBRAMANIYAN, Chennai (IN)

(21) Appl. No.: 15/418,675

(22) Filed: Jan. 28, 2017

Related U.S. Application Data
(60) Provisional application No. 62/287,911, filed on Jan. 28, 2016.

(51) Int. Cl. G06Q 30/02; H04W 4/02

(52) U.S. Cl. CPC G06Q 30/0261; H04W 4/02; H04W 4/06

(57) ABSTRACT

Disclosed is a method and system to broadcast and receive data for advertising. In one implementation, the method comprises receiving data and metadata associated with the data. Upon receiving, the method comprises identifying whether the data is at least one of an advertisement or an index, and comparing the size of the data and a maximum beacon size. Further to comparing, the method comprises transmitting the data and the metadata to one or more mobile devices in the vicinity. In one example, when the size of the data is greater than the maximum beacon size and the data is the index, a record-by-record transmission process may be utilized for the transmission. In other example, when the size of the data is greater than the maximum beacon size and the data is the advertisement, a splitting process may be may be utilized for the transmission.

### CROSS REFERENCE TO RELATED APPLICATIONS AND PRIORITY

The present application claim priority from U.S. Provisional application 62/287,911 filed on 28^{th} Jan. 2016.

### TECHNICAL FIELD

The present subject matter described herein, in general, relates to wifeless communications, and more particularly a system and a method to broadcast and receive data for advertising.

### BACKGROUND

Nowadays, beacon devices are installed at supermarkets, convenience stores, department stores, and other place to transmit data related to product, coupons, discounts, offers and the like to mobile devices, which is further processed and displayed to the user. Typically, the beacons devices continuously transmit a beacon signal for a predetermined period. In particular, beacon devices uses Bluetooth to transmit a universally unique identifier, which is received by a compatible app or operating system, installed on the mobile devices. Generally, on receiving the universally unique identifier the compatible app or operating system uses the universally unique identifier to fetch the advertisement from the internet/cloud. These conventional processes of advertising fail when an Internet connection is unavailable at the mobile device. In addition, there is no cleaner and secured mechanism to broadcast an advertisement.

### SUMMARY

Before the present systems and methods to broadcast and receive data for advertising, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to a system and a method to broadcast and receive data for advertising. This summary is not intended to identify essential features of the claimed subject matter nor is it intended for use in determining or limiting the scope of the claimed subject matter.

In one implementation, a beacon device to broadcast data for advertising is disclosed. In one aspect, the beacon device comprises a memory and a processor coupled to the memory. Further, the processor may be capable of executing instructions in the memory to perform one or more steps. In the aspect, the beacon device may receive data and metadata associated with the data. In one example, the metadata may comprise instructions associated with an encryption of the data and information associated with a size of the data. Upon receiving, the beacon device may identify whether the data is at least one of an advertisement or an index, and compare the size of the data and a maximum beacon size. In one example, the advertisement may be associated to one or more stores in the vicinity, and the index may comprise one or more records indicating at least a location of the advertisement. Further to comparing, the beacon device may transmit the data and the metadata to one or more mobile devices in the vicinity. In one example, the beacon device may use at least one of a record-by-record transmission process when the size of the data is greater than the maximum beacon size and the data is the index, or a splitting process when the size of the data is greater than the maximum beacon size and the data is the advertisement.

In one implementation, a mobile device to receive data for advertising is disclosed. In one aspect, the mobile device comprises a memory and a processor coupled to the memory. Further, the processor may be capable of executing instructions in the memory to perform one or more steps. In the aspect, the mobile device may receive data and metadata transmitted by a beacon device. In one example, the data may be at least one of an index or secondary data packets and the metadata may comprise instructions associated with a decryption of the data and a sequence number. Further, in the example the sequence number is received when the data is transmitted by the beacon device using a splitting process. Upon receiving, the mobile device may obtain by at least one of, an advertisement from a local server or an application using the index when the data is the index or by integrating the secondary data packets using the sequence number when the data comprises the secondary data packets. In one example, the index comprises one or more records indicative of the advertisement. Further to obtaining, the mobile device may display the advertisement on the mobile device, thereby enabling advertising using the beacon device.

In one implementation, a method to broadcast data for advertising is disclosed. In one aspect, the method may comprise receiving data and metadata associated with the data and identifying whether the data may be at least one of an advertisement or an index. In one example, the metadata may comprise instructions associated with an encryption of the data and information associated with a size of the data. Further, in the example, the advertisement may be associated to one or more stores in the vicinity, and the index may comprise one or more records indicative of the advertisement. Further, the method may comprise comparing the size of the data and a maximum beacon size and transmitting the data and the metadata to one or more mobile devices in the vicinity. In one example, transmission may use at least one of a record by record transmission process when the size of the data is greater than the maximum beacon size and the data is the index, or a splitting process when the size of the data is greater than the maximum beacon size and the data is the advertisement.

In one implementation, a method to receive data for advertising is disclosed. In one aspect, the method may comprise receiving data and metadata transmitted by a beacon device. In one example, the data may be at least one of an index or secondary data packets and the metadata comprises instructions associated with a decryption of the data and a sequence number. Further, in the example, the sequence number is received when the data is transmitted by the beacon device using a splitting process. The method may comprise obtaining an advertisement. In one example, the advertisement may be obtained from one of from a local server or an application using the index when the data is the index or by integrating the secondary data packets using the sequence number when the data comprises the secondary data packets. In the example, the index may comprise one or more records associated with the advertisement. The method may further comprise displaying the advertisement on the mobile device, thereby enabling advertising using the beacon device.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system to broadcast and receive data for advertising disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system comprising a beacon device to broadcast and a mobile device to receive data for advertising, in accordance with an embodiment of the present subject matter where fetching content would be from a server.

FIG. 2A illustrates the beacon device and its subcomponents to broadcast data for advertising, in accordance with an embodiment of the present subject matter.

FIG. 2B illustrates the mobile device and its subcomponents to receive data for advertising, in accordance with an embodiment of the present subject matter.

FIG. 3A illustrates a method to broadcast for advertising, in accordance with an embodiment of the present subject matter.

FIG. 3B illustrates a method to receive for advertising, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods to broadcast and receive data for advertising, similar or equivalent to those described herein can be used in the practice or testing of embodiments of the present disclosure, the exemplary, systems and methods to broadcast and receive data for advertising are now described. The disclosed embodiments to broadcast and receive data for advertising are merely examples of the disclosure, which may be embodied in various forms.

Various modifications to the embodiment will be readily apparent to those skilled in the art and the generic principles herein may be applied to other embodiments to broadcast and receive data for advertising. However, one of ordinary skill in the art will readily recognize that the present disclosure to broadcast is not intended to be limited to the embodiments described, but is to be accorded the widest scope consistent with the principles and features of a system comprising a beacon device and a mobile device, and a method to broadcast and receive data for advertising is disclosed.

In an implementation, a beacon device and a method to broadcast data for advertising, is described. In an embodiment, data and metadata associated with the data may be received. In one example, the metadata may comprise instructions associated with an encryption of the data and information associated with a size of the data. Upon receiving the data and metadata, it may be identified whether the data may be at least one of an advertisement or an index. Further, in the example, the advertisement may be associated to one or more stores in the vicinity, and the index may comprise one or more records indicative of a location of the advertisement. Subsequent to identification of the data, the size of the data and a maximum beacon size may be compared and the data and the metadata may be transmitted to one or more mobile devices in the vicinity, thereby enabling broadcast of data for advertising. In one example for transmission, a record-by-record transmission process when the size of the data is greater than the maximum beacon size and the data is the index or a splitting process when the size of the data is greater than the maximum beacon size and the data is the advertisement may be utilized.

In another implementation, a mobile device and a method to receive data for advertising, is described. In an embodiment, data and metadata transmitted by a beacon device may be received. In one example, the data may be an index or secondary data packets and the metadata may comprise instructions associated with a decryption of the data and a sequence number. Further, in the example, the sequence number may be received when the data is transmitted by the beacon device using a splitting process. Upon receiving data and metadata, an advertisement may be obtained. In one example, when the data is the index, the advertisement may be obtained from one of from a local server or an application using the index. In the example, the index may comprise one or more records associated with the advertisement for example, indicating what is the advertisements and how it is to be fetched. In other example, when the data comprises the secondary data packets, the advertisement may be obtained by integrating the secondary data packets using the sequence number. Further to obtaining the advertisement, the advertisement may be displayed on the mobile device, thereby enabling advertising using the beacon device.

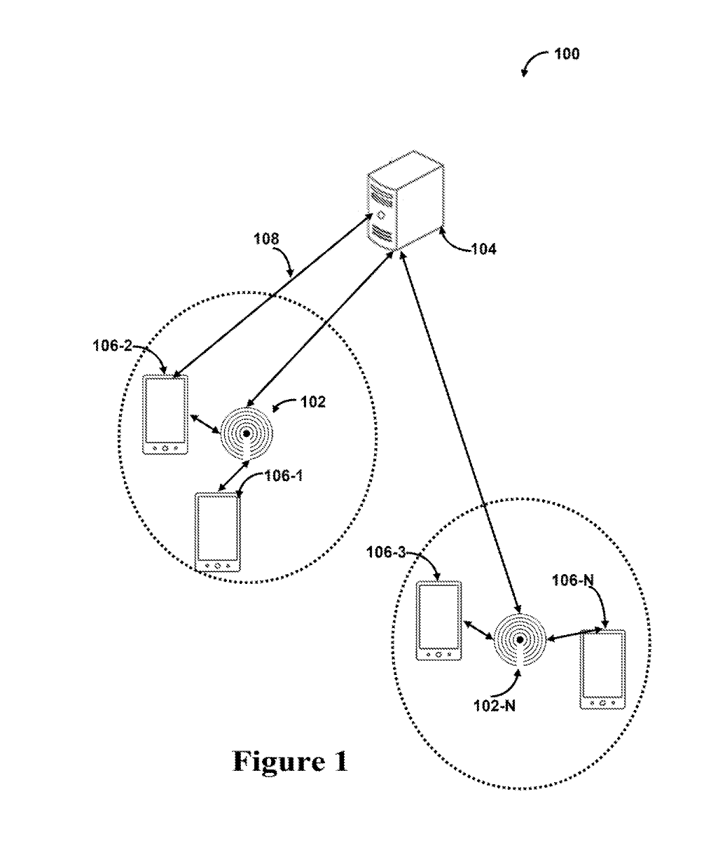

Referring now to FIG. 1, a network implementation 100 of a system comprising the beacon devices 102-1 . . . 102-N, and the mobile device 106-1 . . . 106-N to broadcast and receive data for advertising, in accordance with an embodiment of the present subject matter may be described. In one embodiment, the present subject matter is explained considering that the beacon devices 102-1 . . . 102-N are performing the method. In one example, the method for broadcasting data may be performed by a system implemented on a server 104 and connected to the beacon devices 102-1 . . . 102-N. It may be understood that the system 102 may also be implemented in a variety of computing systems, such as a laptop computer, a desktop computer, a notebook, a workstation, a mainframe computer, a server, a network server, and the like.

In one example, mobile devices 106-1 . . . 106-N (herein after individually and collectively referred to as mobile device(s) 106) may be a mobile phone or a laptop or like devices capable to communicate with the beacon devices 102-1 . . . 102-N (herein after individually and collectively referred to as beacon device(s) 102 or 102-1 . . . 102-N). In one example, the beacon device(s) 102 may be a Bluetooth low energy devices. It may also be understood that the mobile devices 106-1 . . . 106-N and the beacon devices 102-1 . . . 102-N supports a plurality of browsers and all viewports. Examples of the plurality of browsers may include, but not limited to, Chrome™, Mozilla™, Internet Explorer™, Safari™, and Opera™ Furthermore, the mobile devices 106-1 . . . 106-N and the beacon devices 102-1 . . . 102-N may be communicatively coupled to a database for storing data. In one example, the database may be any of the relationship database and the like.

In one embodiment of the present subject matter, the beacon devices 102 may receive data and metadata associated with the data. In one example, the metadata may comprise at least an information associated with a size of the data. In one other embodiment, the beacon devices 102 may be pre-programmed with data or the advertisement. In one other embodiment, the advertisements/index may be stored in a memory card on the beacon device 102. In the embodiment, the beacon device may be programmed to select the advertisement/index from the memory card and perform the next steps. In above embodiments, the beacon device may not be connected to the data centre/their local server. Further, the beacon device 102 may be re-programed using a server when a change in advertisement is required. In other embodiment the beacon device 102 may be connected the server/data centre and the content to advertised could be selected dynamically and obtained by the beacon device to perform next steps.

Upon receiving the data and metadata, the beacon devices 102 may identify whether the data may be at least one of an advertisement or an index. Further, in the example, the advertisement may be associated to one or more stores in the vicinity, and the index may comprise one or more records indicating what content and how it is to be fetched. Subsequent to identification of the data, the beacon devices 102 may compare the size of the data and a maximum beacon size and the data and the metadata may be transmitted to one or more mobile devices 106 in the vicinity, thereby enabling broadcast of data for advertising. In one example for transmission, the beacon devices 102 may use a record-by-record transmission process when the size of the data is greater than the maximum beacon size and the data is the index. In one other example, the beacon devices 102 may use a splitting process when the size of the data is greater than the maximum beacon size and the data is the advertisement may be utilized.

In one other implementation, the mobile devices 106 may receive data and metadata transmitted by the beacon device 102. In one example, the data may be an index or secondary data packets and the metadata may comprise a sequence number. Further, in the example, the sequence number may be received when the data is transmitted by the beacon device 102 using a splitting process. Upon receiving data and metadata, the mobile devices 106 may obtain an advertisement. In one example, the mobile devices 106 may obtain the advertisement from one of from a local server in the LAN/Wi-Fi network 108 or the application or local data storage of the mobile device 106 when the data is the index. In the example, the index may comprise one or more records indicative of a location of the advertisement in the local server or an application or local data storage. In other example, when the data comprises the secondary data packets, the mobile devices 106 may obtain the advertisement by integrating the secondary data packets using the sequence number. Further to obtaining the advertisement, the mobile devices 106 may display the advertisement which may not just be limited to video/audio/text and not limited to this the mobile device 106, thereby enabling advertising using the beacon device 102.

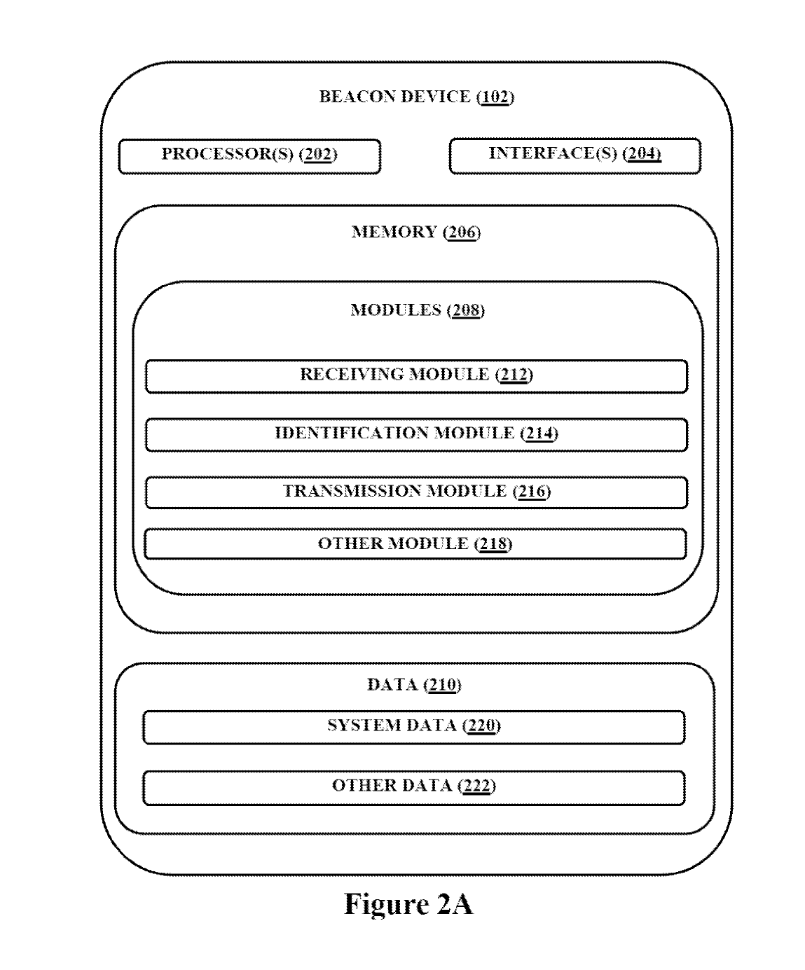

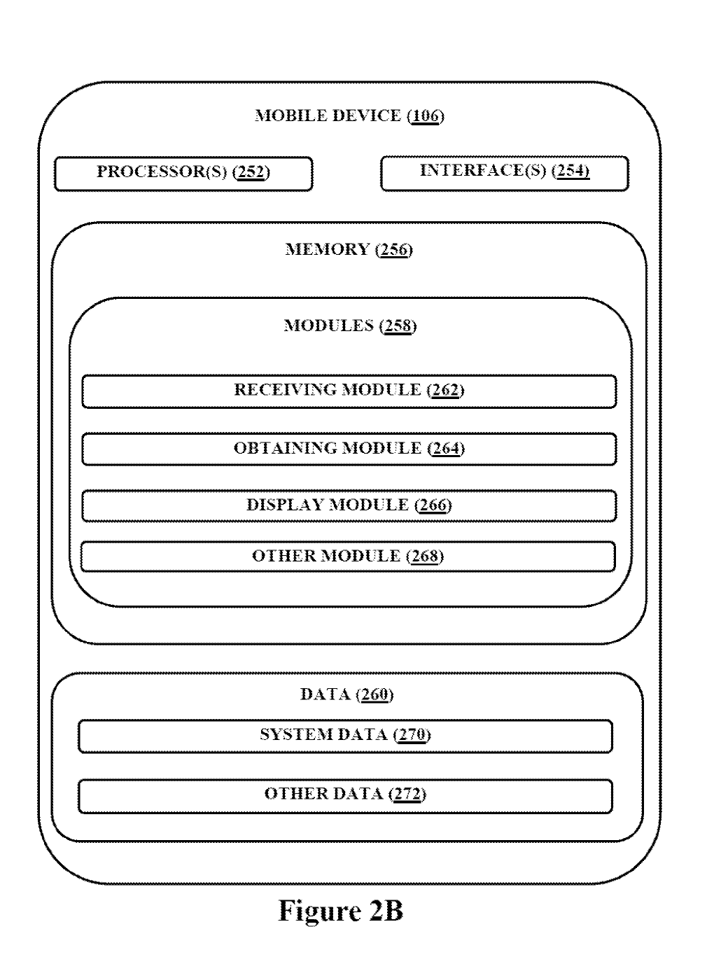

Referring now to FIG. 2A, the beacon devices 102 for broadcasting data for advertising is illustrated in accordance with an embodiment of the present subject matter. In one embodiment, the beacon devices 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, FPGAs, PLDs and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the beacon devices 102 to interact with the user directly. Further, the I/O interface 204 may enable the beacon devices 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, GSM or CDMA cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206, amongst other things, serves as a repository for storing data processed, received, and generated by one or more of the modules 208. The memory 206 may include modules 208 and data 210.

The modules 208 include routines, programs, objects, components, data structures, etc., which perform particular tasks or implement particular abstract data types. In one implementation, the modules 208 may include a receiving module 212, an identification module 214, a transmission module 216 and other module 218. The other modules 218 may include programs or coded instructions that supplement applications and functions of the beacon devices 102. The modules 208 described herein may be implemented as software modules that may be executed in the beacon devices 102.

The data 210 may include data generated as a result of the execution of one or more modules 208. Further, the data 210 may include a system data 220 for storing data processed, computed received and generated by the receiving module 212, the identification module 214, and the display module 216. Furthermore, the data 210 may include other data 222 for storing data generated because of the execution of one or more modules in the other module 218.

In one implementation, at first, an administrator may access the beacon devices 102 via the I/O interface 204. The administrator may register using the I/O interface 204 in order to use the beacon devices 102. In one aspect, the user may access the I/O interface 204 of the beacon devices 102 for obtaining information, providing input information or configuring the beacon devices 102.

### Receiving Module 212

In the implementation, the receiving module 212 may receive data and metadata associated with the data. In one example, the metadata may comprises instructions associated with an encryption of the data, such as perform encryption or do not perform encryption and encryption key. In the example, the instructions may also comprises instruction on the type of encryption to be uses for example, symmetric key or private key or public key. In one other example, the metadata may also comprises information associated with a size of the data, such as size=200 MB. Further, the receiving module 212 may store the data and metadata in the system data 220.

In one other embodiment, the receiving module 212 may be pre-programmed with data or the advertisement. In one other embodiment, the advertisements/index may be stored in a memory card on the beacon device. In the embodiment, the receiving module 212 may select the advertisement/index from the memory card and perform the next steps. In above embodiments, the beacon device may not be connected to the data centre/their local server. Further, the receiving module 212 may be re-programed using a server when a change in advertisement is required. In other embodiment the receiving module 212 may be connected the server/data centre. Further, the receiving module 212 may select the data dynamically from the server and perform next steps.

### Identification Module 214

In the implementation, upon receiving data and metadata, the identification module 214 may identify whether the data is at least one of an advertisement or an index. In one example, the advertisement may be an image, a video, an audio, content or the like for promoting a product or a store and associated to one or more stores near the mobile device. In one example, the index may comprise one or more records indicative of a location of the advertisement on the local server or an application installed or stored on the mobile device. In one other example, the data may be a combination of the advertisement or the index, for example, Product code index (index), Discount percent (advertisement), offer validity (advertisement), terms and conditions (advertisement) Store Index (index). In one other example, the index may also comprise information on what is the advertisement and how to fetch the advertisement. The index may be a table of content with images. In one example, the table of content may be a static table or a dynamic table.

Further to identification, the identification module 214 may compare the size of the data and a maximum beacon size. In one example, the maximum beacon size may be understood the maximum size of data a beacon device can broadcast, such as 10 MB.

### Transmission Module 216

In the implementation, upon identification and comparison, the transmission module 216 may transmitting the data and the metadata to one or more mobile devices in the vicinity. Further, the transmission module 216 may utilize a record-by-record transmission process or a splitting process for transmission of the data and the metadata. In one example, the transmission module 216 may transmit first the metadata and then the data.

In one example, the transmission module 216 may use the record-by-record transmission process when the size of the data is greater than the maximum beacon size and the data is the index. In the record-by-record transmission process, the transmission module 216 may transmit the one or more records, in the index, one after another. In one example, an identification number may be appended to the records in the metadata before transmission. The identification number may be used to identify records that have failed to reach the mobile device upon transmission.

In other example, the transmission module 216 may use the splitting process when the size of the data is greater than the maximum beacon size and the data is the advertisement. In the splitting process the transmission module 216 may divide the data into secondary data packets. In one example, a size of the secondary data packets may be less than or equal to the maximum beacon size. Upon dividing, the transmission module 216 may assign a sequence number to the secondary data packets. The sequence number may be indicative of the order of the secondary data packets. Further, the sequence number may be appended within the metadata. In one other example of the sequence number, a bit such as first-frame-bit, mid-frame-bit or last-frame-bit may be appended to the metadata.

In one more implementation prior to transmission, the transmission module 216 may encrypt the data based on the instructions for encryption in the metadata. In one example, the transmission module 216 may first analyse the metadata comprising instructions, such as to encrypt or not to encrypt and type of encryption. The beacon device and mobile device are pre-programmed with pre-shared keys and it may be updated through applications update on the mobile device if required. Upon analysing, the transmission module 216 may encrypt the data and append the encryption and decryption information in the metadata.

In one more implementation, upon transmission of the data and the metadata the transmission module 216 may receive from the one or more mobile devices a retransmission request. The retransmission request may comprise information associated with a portion of the data not received by the mobile devices. In one example, the retransmission request may comprises the sequence number or identification number of the secondary packets or the records not received by the mobile devices. Upon receiving, the transmission module 216 may identify and transmit the portion of the data to the one or more one or more mobile devices based on the retransmission request.

Referring now to FIG. 2B, the mobile devices 106 for broadcasting data for advertising is illustrated in accordance with an embodiment of the present subject matter. In one embodiment, the mobile devices 106 may include at least one processor 252, an input/output (I/O) interface 254, and a memory 256. The at least one processor 252 may be implemented as one or more microprocessors, microcomputers, microcontrollers, digital signal processors, central processing units, state machines, logic circuitries, FPGAs, PLDs and/or any devices that manipulate signals based on operational instructions. Among other capabilities, the at least one processor 252 may be configured to fetch and execute computer-readable instructions stored in the memory 256.

The I/O interface 254 may include a variety of software and hardware interfaces, for example, a web interface, a graphical user interface, and the like. The I/O interface 254 may allow the mobile devices 106 to interact with the user directly. Further, the I/O interface 254 may enable the mobile devices 106 to communicate with other computing devices, such as web servers and external data servers (not shown). The I/O interface 254 can facilitate multiple communications within a wide variety of networks and protocol types, including wired networks, for example, LAN, cable, etc., and wireless networks, such as WLAN, GSM or CDMA cellular, or satellite. The I/O interface 254 may include one or more ports for connecting a number of devices to one another or to another server.

The memory 256 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 256, amongst other things, serves as a repository for storing data processed, received, and generated by one or more of the modules 208. The memory 256 may include modules 258 and data 260.

The modules 258 include routines, programs, objects, components, data structures, etc., which perform particular tasks or implement particular abstract data types. In one implementation, the modules 208 may include a receiving module 262, an obtaining module 264, a display module 266 and other module 268. The other modules 268 may include programs or coded instructions that supplement applications and functions of the mobile devices 106. The modules 258 described herein may be implemented as software modules that may be executed in the mobile devices 106.

The data 260 may include data generated because of the execution of one or more modules 258. Further, the data 210 may include a system data 220 for storing data processed, computed received and generated by the receiving module 262, the obtaining module 264, and the display module 266. Furthermore, the data 260 may include other data 272 for storing data generated because of the execution of one or more modules in the other module 268.

In one implementation, at first, an administrator may access the mobile devices 106 via the I/O interface 254. The administrator may register using the I/O interface 254 in order to use the mobile devices 106. In one aspect, the user may access the I/O interface 254 of the mobile devices 106 for obtaining information, providing input information or configuring the mobile devices 106.

### Receiving Module 262

In the implementation, the receiving module 262 may receive data and metadata transmitted by a beacon device. In one example, the receiving module 262 may first receive the metadata and then the data. In one example, the data may be an index or secondary data packets, and the metadata may comprise instructions associated with a decryption of the data, length of data, and a sequence number or an identification number. In one more example, the sequence number is received when the beacon device using a splitting process transmits the data and the identification number is received when the beacon device using a record-by-record transmission transmits the data. Further, in the receiving module 262 may store the data and metadata in the system data 270.

In one more implementation, the receiving module 262 may monitor the received data. During monitoring, receiving module 262 may ascertain if the all data is received based on the metadata and identifying a portion of the data that has not been received from the beacon devices. In one example, further to identification, the receiving module 262 receive the portion in the next transmission cycle of the beacon device using the sequence number or the identification number. In other example, further to identification, the receiving module 262 may transmit a retransmission request to the beacon device. The retransmission request may comprise information associated with the portion of the data not received by the mobile device.

### Obtaining Module 264

In the implementation, upon receiving the data and the metadata, the obtaining module 264 may obtain an advertisement. Further, the obtaining module 264 may store the advertisement in the system data 270.

In one example when the data is the index, the obtaining module 264 may obtain the advertisement from a local server or an application installed on the mobile device using the index. In the example, the index may comprise one or more records indicative of a location of the advertisement. In other words, index may be understood as an indicator to the obtaining module 264 to obtain the advertisement such as image, video, audio, or content already store ion the mobile device or from a local server. In one example, the index may also Product code (X), Discount percent (Y), Store Index (Z). However, the information provided part of indexing is not just limited to this information.

In other example when the data comprises the secondary data packets, the obtaining module 264 may integrate the secondary data packets using the sequence number and obtain an advertisement.

In other example, when the data comprises a combination of index and secondary data packet. The obtaining module 264 may obtain first data based on integration of the secondary data packets using the sequence number and obtain second data associated with the index from a local server or an application installed on the mobile device. Upon obtaining and integrating, the obtaining module 264 may generate the advertisement based on combination of the first data and the second data.

### Display Module 266

In the implementation, upon obtain the advertisement; the display module 266 may analysis the metadata to identify information on decryption. In example, the information may comprises if the data is encrypted or not, type of encryption, and decryption key. Further, the display module 266 may decrypt the data based on metadata and a preconfigured private key. In one other example, the display module 266 may decrypt the data using a pre-shared key associated with a registered mobile. In one example, the display module 266 may prompt the user of the mobile to enter a pre-shared key for decryption. Further, if the user enters the same pre-shared key on a different receiving device, the display module 266 would flash an error message and would not allow display of the advertisement. Upon decryption, the display module 266 may display the advertisement on the mobile device, thereby enabling advertising using the beacon device.

Exemplary embodiments to broadcast and receive data for advertising discussed above may provide certain advantages. Though not required to practice aspects of the disclosure, these advantages may include those provided by the following features.

Some embodiments of the system and the method enable advertisement in absence of cloud-server.

Some embodiments of the system and the method enable advertisement in absence of internet.

Some embodiments of the system and the method enable a secure communication link for advertisement even when there is no internet/cloud server.

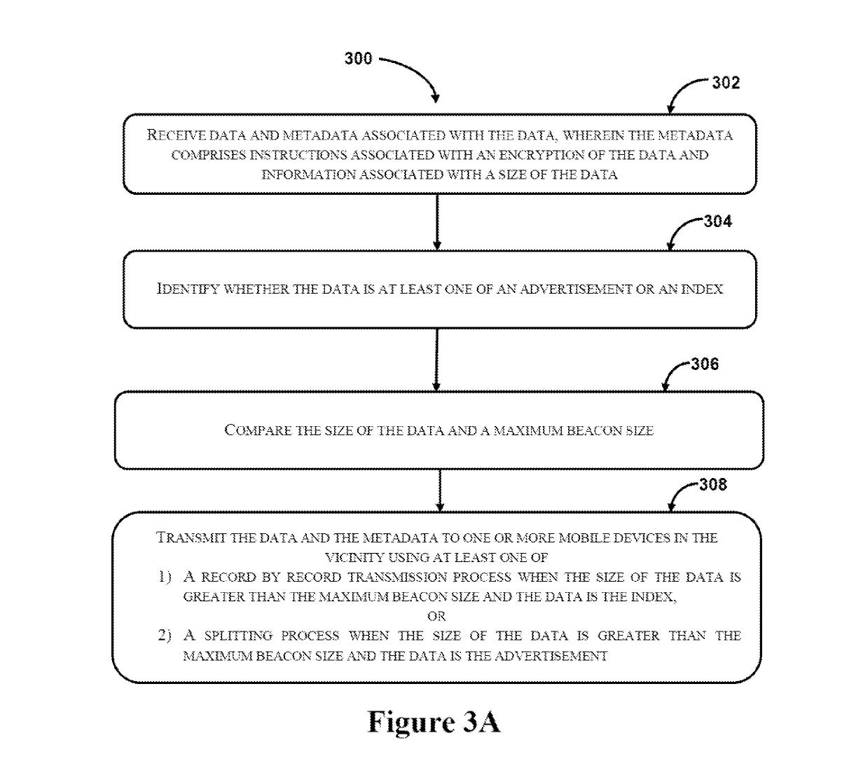

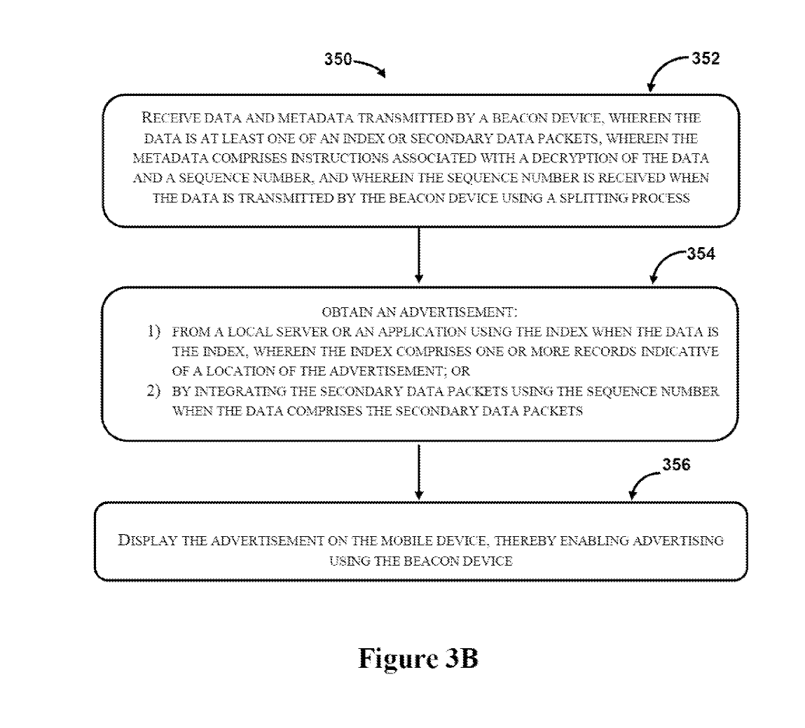

Referring now to FIG. 3A, a method 300 to broadcast data for advertising is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 to broadcast data for advertising as described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described beacon device 102.

At block 302, data and metadata associated with the data may be received. In one example, the metadata may comprise instructions associated with an encryption of the data and information associated with a size of the data. In an implementation, the receiving module 212 may receive data and metadata associated with the data. Further, the receiving module 212 may store the data and metadata in the system data 220.

At block 304, whether the data is at least one of an advertisement or an index may be identified. In one example, the advertisement may be associated to one or more stores in the vicinity, and the index may comprise one or more records indicative of a location of the advertisement. In an implementation, the identification module 214 may identify whether the data is at least one of an advertisement or an index and may store identification data in the system data 220.

At block 306, the size of the data and a maximum beacon size may be compared. In the implementation, the identification module 214 may compare the size of the data and a maximum beacon size and store comparison data in the system data 220.

At block 308, the data and the metadata may be transmitted to one or more mobile devices in the vicinity. In one example, when the size of the data is greater than the maximum beacon size and the data is the index, a record-by-record transmission process may be used for the transmission. In other example, when the size of the data is greater than the maximum beacon size and the data is the advertisement a splitting process may be used for the transmission. In the implementation, the transmission module 216 may transmit the data and the metadata to one or more mobile devices using one of the record-by-record transmission process or the splitting process.

Referring now to FIG. 3B, a method 350 to receive data for advertising is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 350 to receive data for advertising as described is not intended to be construed as a limitation, and any number of the described method blocks can be combined in any order to implement the method 350 or alternate methods. Additionally, individual blocks may be deleted from the method 350 without departing from the spirit and scope of the subject matter described herein. Furthermore, the method can be implemented in any suitable hardware, software, firmware, or combination thereof. However, for ease of explanation, in the embodiments described below, the method 350 may be considered to be implemented in the above-described mobile device 106.

At block 352, data and metadata transmitted by a beacon device may be received. In one example, the data may be an index or secondary data packets, and the metadata comprises instructions associated with a decryption of the data and a sequence number. Further, in the example, the sequence number may be received when the data is transmitted using a splitting process. In an implementation, the receiving module 262 may a receive data and metadata transmitted by the beacon device store the data and metadata in the system data 270.

At block 354, an advertisement may be obtained. In one example, when the data is the index, the advertisement may be obtained from a local server or an application installed on the mobile device using the index. In other example, when the data is the secondary data packets, the advertisement may be obtained by integrating the secondary data packets using the sequence number. In an implementation, the obtaining module 264 may obtain the advertisement and store the advertisement in the system data 270.

At block 356, displaying the advertisement on the mobile device, thereby enabling advertising using the beacon device. In the implementation, the display module 216 may display the advertisement on the mobile device.

Exemplary embodiments discussed above may provide certain advantages. Though not required to practice aspects of the disclosure, these advantages may include a method and system to broadcast and receive data for advertising. Although implementations for methods and systems to broadcast and receive data for advertising have been described in language specific to structural features and/or methods, it is to be understood that the appended claims are not necessarily limited to the specific features or methods described. Rather, the specific features and methods of the beacon device and the mobile device are disclosed as examples of implementations to broadcast and receive data for advertising.

1. A method for broadcasting data, the method comprising:
receiving data and metadata associated with the data, wherein the metadata comprises instructions associated with an encryption of the data and information associated with a size of the data;
identifying whether the data is at least one of an advertisement or an index, wherein the advertisement is associated to one or more stores in the vicinity, and wherein the index comprises one or more records indicative of a location of the advertisement;
comparing the size of the data and a maximum beacon size; and
transmitting the data and the metadata to one or more mobile devices in the vicinity using at least one of:
a record-by-record transmission process when the size of the data is greater than the maximum beacon size and the data is the index, or
a splitting process when the size of the data is greater than the maximum beacon size and the data is the advertisement.

2. The method of claim 1, further comprises encrypting the data based on the metadata.

3. The method of claim 1, wherein the maximum beacon size is indicative of the maximum size of data a beacon device can broadcast.

4. The method of claim 1, wherein the splitting process comprises:
dividing the data into secondary data packets, wherein a size of the secondary data packets is less than or equal to the maximum beacon size; and
assigning a sequence number to the secondary data packets, wherein the sequence number is indicative of the order of the secondary data packets, and wherein the sequence number is appended within the metadata.

5. The method of claim 1, further comprises
receiving from the one or more mobile devices a retransmission request, wherein the retransmission request comprises information associated with a portion of the data not received by the one or more mobile devices; and
transmitting the portion of the data to the one or more one or more mobile devices based on the retransmission request.

6. A method for receiving broadcasted data, the method comprising:
receiving data and metadata transmitted by a beacon device, wherein the data is at least one of an index or secondary data packets, wherein the metadata comprises instructions associated with a decryption of the data and a sequence number, and wherein the sequence number is received when the data is transmitted by the beacon device using a splitting process; and
obtaining, by at least one of, an advertisement:
from a local server or an application using the index when the data is the index, wherein the index comprises one or more records indicative of a location of the advertisement; or
by integrating the secondary data packets using the sequence number when the data comprises the secondary data packets;
displaying the advertisement on the mobile device, thereby enabling advertising using the beacon device.

7. The method of claim 6, further comprises decrypting one of the data or the plurality of secondary data based on metadata and a preconfigured private key.

8. The method of claim 6, further comprises
identifying a portion of the data and the metadata that has not been received;
transmitting a retransmission request to the beacon device, wherein the retransmission request comprises information associated with the portion of the data not received by the one or more mobile devices

9. A beacon device for broadcasting data, the system comprising:
a memory; and
a processor coupled to the memory, wherein the processor is capable of executing instructions to perform steps of:
receiving data and metadata associated with the data, wherein the metadata comprises instructions associated with an encryption of the data and information associated with a size of the data;
identifying whether the data is at least one of an advertisement or an index, wherein the advertisement is associated to one or more stores in the vicinity, and wherein the index comprises one or more records indicative of a location of the advertisement;
comparing the size of the data and a maximum beacon size; and
transmitting the data and the metadata to one or more mobile devices in the vicinity using at least one of:
a record by record transmission process when the size of the data is greater than the maximum beacon size and the data is the index, or
a splitting process when the size of the data is greater than the maximum beacon size and the data is the advertisement.

10. The beacon device of claim 9, further comprises encrypting the data based on the metadata.

11. The beacon device of claim 9, wherein the maximum beacon size is indicative of the maximum size of data a beacon device can broadcast.

12. The beacon device of claim 9, wherein the splitting process comprises:
dividing the data into secondary data packets, wherein a size of the secondary data packets is less than or equal to the maximum beacon size; and
assigning a sequence number to the secondary data packets, wherein the sequence number is indicative of the order of the secondary data packets, and wherein the sequence number is appended within the metadata.

13. The beacon device of claim 9, further comprises
receiving from the one or more mobile devices a retransmission request, wherein the retransmission request comprises information associated with a portion of the data not received by the one or more mobile devices; and
transmitting the portion of the data to the one or more one or more mobile devices based on the retransmission request.

14. A mobile device for receiving broadcasted data, the method comprising:
a memory; and
a processor coupled to the memory, wherein the processor is capable of executing instructions to perform steps of:
receiving data and metadata transmitted by a beacon device, wherein the data is at least one of an index or secondary data packets, wherein the metadata comprises instructions associated with a decryption of the data and a sequence number, and wherein the sequence number is received when the data is transmitted by the beacon device using a splitting process;
obtaining an advertisement:
from a local server or an application using the index when the data is the index, wherein the index comprises one or more records indicative of a location of the advertisement; or
by integrating the secondary data packets using the sequence number when the data comprises the secondary data packets; and
displaying the advertisement on the mobile device, thereby enabling advertising using the beacon device.

15. The mobile device of claim 14, further comprises decrypting one of the data or the plurality of secondary data based on metadata and a preconfigured private key.

16. The mobile device of claim 14, further comprises
identifying a portion of the data and the metadata that has not been received; and
transmitting a retransmission request to the beacon device, wherein the retransmission request comprises information associated with the portion of the data not received by the one or more mobile devices.
